(19) United States
(12) Patent Application Publication
(10) Pub. No.: US 2002/0072916 A1
(43) Pub. Date: Jun. 13, 2002

(54) Distributed speech recognition for internet access

(75) Inventor: Theodore D. Friedman, San Francisco, CA (US)

Correspondence Address: Edward Blocker, c/o Philips Electronics North America Corporation, Corporate Intellectual Property Department, 580 White Plains Road, Tarrytown, NY, 10591-5190, US

(73) Assignee: PHILIPS ELECTRONICS NORTH AMERICA CORPORATION

(21) Appl. No.: 09/733,880

(22) Filed: Dec. 8, 2000

(51) Int. Cl. G10L 11/00

(52) U.S. Cl. 704/270.1

(57) ABSTRACT

A search server provides a user address to an information source, to effect an access of the information source by the user. The user sends a request to the search server, and the search server identifies an address (URL) of an information source corresponding to the request. The request may be a verbal request, or model data corresponding to a verbal request, and the search server may include a speech recognition system. Thereafter, the search server communicates a request to the identified information source, using the user's address as the “reply-to address” for responses to this request. The user's address may be the address of the device that the user used to communicate the initial request, or the address of another device associated with the user.

### BACKGROUND OF THE INVENTION

1. Field of the Invention

This invention relates to the field of communications, and in particular to providing Internet access via spoken commands.

2. Description of Related Art

Speech recognition systems convert spoken words and phrases into text strings. Speech recognition systems may be ‘local’ or ‘remote’, and/or may be ‘integrated’ or ‘distributed’. Often, remote systems include components at a user's local site, while providing the bulk of the speech recognition system at a remote site. Thus, the terms remote and distributed are often used interchangeably. In like manner, some local networks, such as a network in an office environment, may include application servers and file servers that provide servers to user stations. Applications that are provided by such application servers are conventionally considered to be ‘distributed’, even if the application, such as a speech recognition application, resides totally on an application server. For the purposes of this disclosure, the term ‘distributed’ is used in the broadest sense, and encompasses any speech recognition system that is not integrated within the application that is provided text strings from spoken commands. Generally, such distributed speech recognition systems receive a spoken phrase, or an encoding of a spoken phrase, from a voice-input control application, and returns the corresponding text string to the control application for routing to the appropriate application program.

FIG. 1 illustrates a conventional general-purpose speech recognition system 100. The speech recognition system 100 includes a controller 110, a speech recognizer 120, and a dictionary 125. The controller 110 includes a speech modeler 112 and a text processor 114. When a user speaks into a microphone 101, the speech modeler 112 encodes the vocal input into model data, the model data being based upon the particular scheme that is used to effect speech recognition. The model data may include, for example, a symbol for each phoneme or group of phonemes, and the speech recognizer 120 is configured to recognize words or phrases based on the symbols, and based on a dictionary 125 that provides the mapping between symbols and text.

The text processor 114 processes the text from the speech recognizer 120 to determine an appropriate action in response to this text. For example, the text may be “Go To Word”, and in reaction to this text, the controller 110 provides appropriate commands to a system 130 to launch a particular word-processing application 140. Thereafter, a “Begin Dictation” text string may cause the controller 110 to pass all subsequent text strings to the application 140, without processing, until an “End Dictation” text string is received from the speech recognizer 120.

The speech recognizer 120 may use any of a variety of techniques for associating text to speech. In a small-vocabulary system, for example, the recognizer 120 may merely select the text whose model data most closely match the model data from the speech modeler. In a large-vocabulary system, the recognizer 120 may use auxiliary information, such as grammar-based rules, to select among viable alternatives that closely match the model data from the speech modeler. Techniques for converting speech to text are common in the art. Note that the text that is provided from the speech recognizer need not be a direct translation of the spoken phrases. The spoken phrase “Call Joe”, for example, may result in a text string of “1-914-555-4321” from the dictionary 125. In a distributed speech recognition system, the speech recognizer 120 and all or part of the dictionary 125 may be a separate application from the speech modeler 112 and text processor 114. For example, the speech recognizer 120 and dictionary 125 may be located at a remote Internet site, and the speech modeler 112 at a local site, to minimize the bandwidth required to communicate the user's speech to the recognizer 120.

European Patent Application EP0982672A2 “INFORMATION RETRIEVAL SYSTEM WITH A SEARCH ASSIST SERVER”, filed Aug. 25, 1999, for Ichiro Hatano, incorporated by reference herein, discloses an information retrieval system having a list of identifiers to access each of a plurality of information servers, such as Internet sites. The list of identifiers that is associated with each information server includes a variety of means for identifying the server, including a “pronunciation” identifier. When a user's spoken phrase corresponds to the pronunciation-identifier of a particular information server, the location of the information server, for example, the server's Universal Resource Locator (URL), is retrieved. This URL is then provided to an application that retrieves information from the information server at this URL. Commercial applications, such as the mySpeech application from Spridge, Inc., provide a similar capability that is targeted for mobile web access via Internet-enabled phone instruments.

FIG. 2 illustrates an example embodiment of a special purpose speech processing system that is configured to facilitate access to particular Internet web sites. A URL search server 220 receives input from a user station 230, via the Internet 250. The input from the user station 230 includes model data corresponding to input from the microphone 201, as well as a “reply-to” address that the search server 220 uses to direct the results of the processing of the user input. In this application, the results of the processing of the user input is either a “not-found” message, or a message that contains the URL of the site that corresponds to the user's input. The user station 230 uses the provided URL to send a message to the information source 210, as well as the aforementioned “reply-to” address that the information source 210 uses to send messages back to the user. Typically, the message from the information source 210 is a web page. Note that if the user station 230 is a mobile device, the Wireless Access Protocol (WAP) will typically be used. A WAP message from the information source 210 will be a set of ‘cards’ from a ‘deck’ that is encoded using the Wireless Markup Language (WML).

### BRIEF SUMMARY OF THE INVENTION

It is an object of this invention to improve the efficiency of an Internet access via a speech recognition system. It is a further object of this invention to improve the efficiency of an Internet access via a mobile device. It is a further object of this invention to improve the response time of an Internet access.

These objects and others are achieved by providing a search server that provides a user address to an information source to effect an access of the information source by the user. The user sends a request to the search server, and the search server identifies an address (URL) of an information source corresponding to the request. The request may be a verbal request, or model data corresponding to a verbal request, and the search server may include a speech recognition system. Thereafter, the search server communicates a request to the identified information source, using the user's address as the “reply-to address” for responses to this request. The user's address may be the address of the device that the user used to communicate the initial request, or the address of another device associated with the user.

### BRIEF DESCRIPTION OF THE DRAWINGS

The invention is explained in further detail, and by way of example, with reference to the accompanying drawings wherein:

FIG. 1 illustrates an example block diagram of a prior art general-purpose speech recognition system.

FIG. 2 illustrates an example block diagram of a prior art search system that includes a speech recognition system.

FIGS. 3A and 3B illustrate example block diagrams of a search system in accordance with this invention.

FIG. 4 illustrates an example flow diagram of a search system in accordance with this invention.

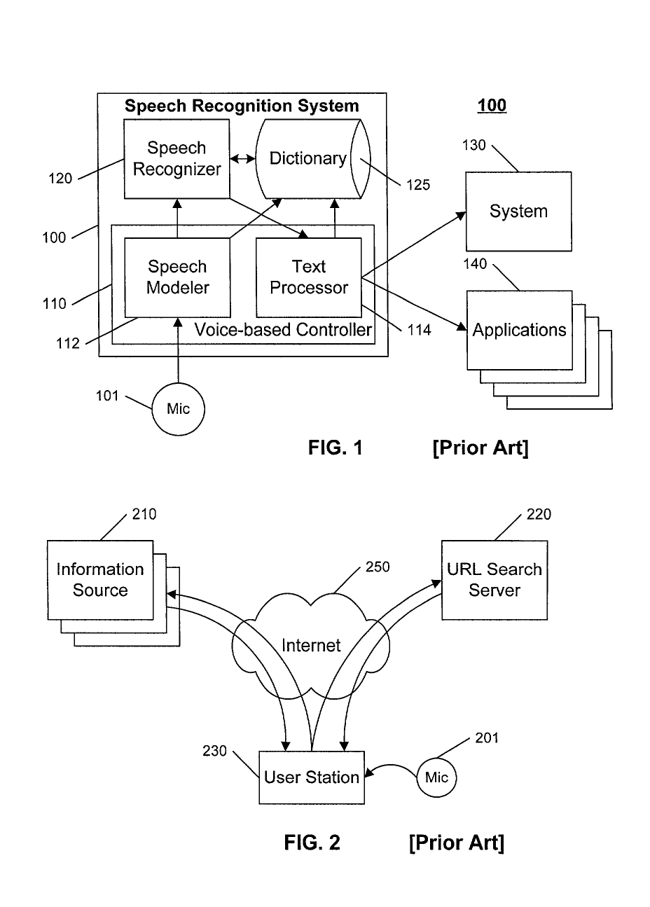

Throughout the drawings, the same reference numerals indicate similar or corresponding features or functions.

### DETAILED DESCRIPTION OF THE INVENTION

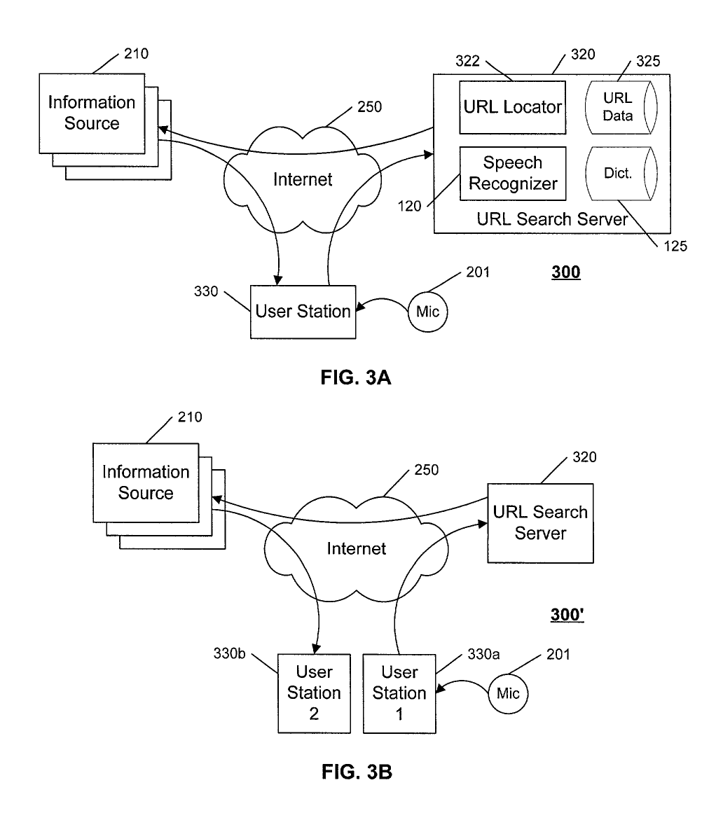

FIGS. 3A and 3B illustrate example block diagrams of a search system 300, 300′ in accordance with this invention. For ease of understanding, the conventional means of effecting communication among each of the components of the system 300, 300′, such as transmitters, receivers, modems, and so on, are not illustrated, but would be evident to one of ordinary skill in the art.

In the example of FIG. 3A, a user submits a request from a user station 330 to a URL search server 320. The search server 320 is configured to determine a single URL corresponding to the user request. As such, it is particularly well suited for use in a speech recognition system, wherein a user uses a key word or phrase, such as “Get Stock Prices”, as a request to access a particular pre-defined web site. The spoken phrase is input to the user station 330 via a microphone 201. The user station 330 may be a mobile telephone, a palm-top device, a portable computer, a desktop computer, a set-top box, or any other device that is capable of providing access to a wide-area network, such as the Internet 250. The access to the network 250 may be via one or more gateways (not illustrated).

In a speech recognition embodiment, the user station preferably encodes the spoken phrase into model data, so that less bandwidth is used to communicate the spoken request to the server 320. The server 320 includes a speech recognizer 120 and a dictionary 125 that convert the model data, as required, into a form that the URL locator 322 uses. For example, in the aforementioned mySpeech application, a user sets up the application database 325 by entering a text string and a corresponding URL, such as:

“Get Stock Prices”, http://www.stocksonline/userpage3/

for each information source 210 that the user expects to access in the future. In the aforementioned EP0982672A2 patent application, the database includes a text encoding of the phonetics of the phrase corresponding to each URL.

Note that although this invention is well suited for speech recognition, and for a distributed speech recognition wherein the speech recognizer 120 is located at the search server 320, the user station 330 may provide the request to the URL location 122 directly. This request may be, for example, a text string entered by the user, the output of a speech recognizer at the user station 330, and so on.

The request from the user, as in a conventional TCP/IP request, includes an address of the source 330 of the request, and/or an explicit “reply-to” address. Conventionally, a search server uses this address to send the identified information source URL back to the user station 330.

In accordance with this invention, the search server 320 communicates a request directly to the identified information source 210, wherein the request identifies the address of the user station 330 as the source of the request, and/or as the explicit “reply-to” address. In this manner, when the information source 210 responds to the request, the response is sent directly to the user station 330. Optionally, the located URL is also sent to the user station 330, for subsequent direct access to the information source 210, if required.

The particular request that is sent from the server 320 may be a fixed request for access to the web site, or, in a preferred embodiment, the form of the request corresponding to each phrase may be included in the database 325. For example, some requests may be conventional requests for a download of a web page at the URL, while others may be sub-commands for accessing information within the web site, via, for example, the selection of an option, a search request, and so on. In addition to phrases that correspond to URLs, the database 325 in a preferred embodiment is also configured to allow other information to be associated with stored phrases. Some phrases, such as numbers or letters, or specific keywords such as “next”, “back”, and “home”, for example, may be defined in the database 325 and in the server 320 so that a corresponding command or string is communicated directly to the information source 210 at the last referenced URL.

FIG. 3B illustrates an alternative embodiment of the invention, wherein there are two, or more, stations 330a, 330b associated with a user. For example, the user station 330a and microphone 201 may be a mobile telephone, and the user station 330b may be a car navigation system. In a preferred embodiment, the user station 330a provides the address of the other user station 330b as the source of the user request, or the explicit “reply-to” address. For ease of reference the term 'source address' is used hereinafter to include either implicit of explicit reply-to addresses. The URL server 320 uses this source address of the second user station 330b as the source address in the request to the located information source 210. This embodiment is particularly well suited for devices 330b that are not configured for voice input, and/or, devices 330a that are not configured for receiving downloaded web pages or WAP decks. For example, a user may encode a string “Show Downtown” in the database 325 with a corresponding URL address of a particular map. The user configures the station 330a to include the address of the station 330b in subsequent requests to the URL search server 320. When the user speaks the phrase “Show Downtown”, the station 330a transmits the model data corresponding to the phrase, with the address of station 330b, to the search server 320. The search server 320 thereafter communicates a request for the particular map to the corresponding information source 210, including the address of station 330b, and the source 210 communicates the map to the station 330b. The user may also encode phrases such as “zoom in”, “zoom out”, “pan north”, and so on, into the database 325, and the search server 320 will communicate corresponding commands to the information source 210, as if the commands had been originated from the station 330b.

In lieu of configuring the user station 330a to include the address of the station 330b in the requests to the server 320, the database 325 can be configured to also contain a field for predefined source URLs for certain phrases. For example, the phrase “Show Downtown Map In Car” could correspond to an address of a map in a “Target URL” field of the database 325, and could correspond to a URL address of a user's car navigation system in a “Source URL” field. These and other options for enhancing the utility of the principles of this invention will be evident to one of ordinary skill in the art.

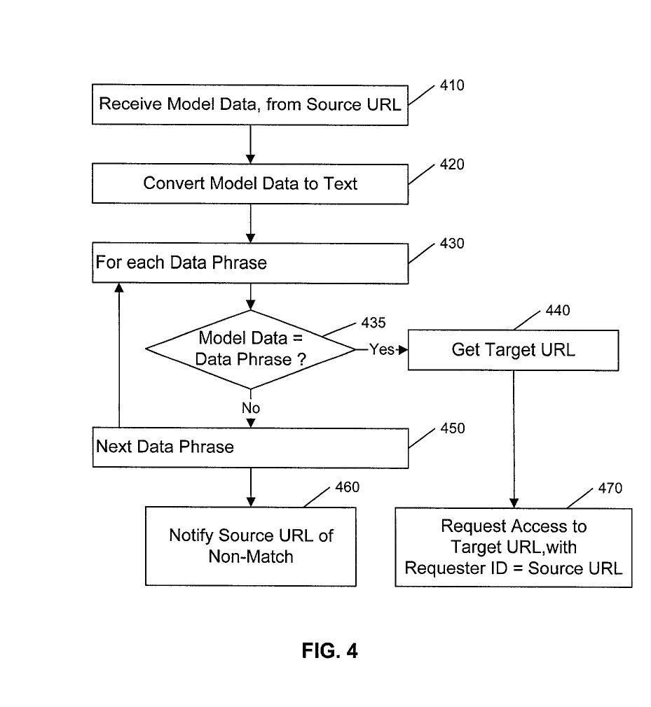

FIG. 4 illustrates an example flow diagram of a search system in accordance with this invention, as might be embodied in a search server 320 of FIG. 3. The example flow diagram of FIG. 4 is not intended to be exhaustive, and it will be evident to one of ordinary skill in the art that alternative processing schemes can be used to effect the options and features discussed above.

At 410, model data corresponding to a vocal input is received, and at 420, this model data is converted to a text string, via a speech recognizer. The message that contains the model data includes an identification of a source URL. The loop 430-450 compares the model data to stored data phrases, as discussed above with regard to the database 325 of the server 320 of FIG. 3. If, at 435, the model data corresponds to a stored data phrase, the corresponding target URL is retrieved, at 440. As noted above, other information, such as corresponding commands or text strings, may also be retrieved. At 470, a request is communicated to the target URL, and this request includes the source address that was received at 410, so that the target URL will respond directly to the original source address, as discussed above. If the model data does not match any of the stored data phrases, the user is notified, at 460.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A search device comprising:
a receiver that is configured to receive a target identifier and a source address from a source device,
a target locator that is configured to identify a target address corresponding to the target identifier, and
a transmitter that is configured to communicate a request to the target address;
wherein
the request includes the source address as an intended recipient of a response to the request from the transmitter of the search device.

2. The search device of claim 1, wherein
the target identifier corresponds to a vocal phrase, and
the search device further includes
a speech recognizer that processes the target identifier to provide an input to the target locator that is used to identify the target address.

3. The search device of claim 1, wherein
the source address corresponds to one of: the source device, and a destination device that differs from the source device.

4. The search device of claim 1, wherein
the transmitter and receiver are configured to communicate via an Internet connection.

5. The search device of claim 4, wherein
the source address and the target address are Universal Resource Locators (URLs).

6. The search device of claim 1, wherein
the receiver is further configured to receive a subsequent input from the source device,
the target locator is further configured to identify a text string corresponding to the subsequent input, and
the transmitter is further configured to communicate the text string to the target address.

7. The search device of claim 6, wherein
the subsequent input corresponds to a vocal phrase, and
the target locator further includes
a speech recognizer that processes the subsequent input to provide the text string.

8. A user device comprising:
an application that is configured
to receive a user input
to transmit a source address, and a target identifier corresponding to the user input, to a locator device, and
to receive a response from a target source corresponding to the target identifier, without initiating a request directly to the target source.

9. The user device of claim 8, wherein
the application transmits to the locator device, and receives from the target source, via an Internet connection.

10. The user device of claim 8, wherein
the user input corresponds to a vocal input, and
the application is further configured to process the vocal input to provide the target identifier.

11. A method of providing a service to a user comprising
receiving a target identifier from the user, and an associated address,
identifying a target address corresponding to the target identifier, and
transmitting a request to the target address;
wherein
the request includes the associated address as an intended recipient of a response to the request.

12. The method of claim 11, wherein
the target identifier corresponds to a vocal phrase, and
the method further includes
processing the target identifier to provide a search item that is used to identify the target address.

13. The method of claim 11, wherein
the associated address corresponds to one of: a source device of the target identifier from the user, and a destination device that differs from the source device.

14. The method of claim 11, wherein
the receiving and transmitting are each effected via an Internet connection.

15. The method of claim 14, wherein
the source address and the target address are Universal Resource Locators (URLs).

16. The method of claim 11, further including
receiving a subsequent input from the user,
identifying a text string corresponding to the subsequent input, and
transmitting the text string to the target address.
